(19) United States
(12) Patent Application Publication
(10) Pub. No.: US 2004/0098750 A1
(43) Pub. Date: May 20, 2004

(54) Method for fixing up last uniform resource locator representing path and file name of multiphoto/video asset

(75) Inventor: Du-Il Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/638,533

(22) Filed: Aug. 12, 2003

(30) Foreign Application Priority Data
Nov. 15, 2002 (KR) 2002-71171

(51) Int. Cl. H04N 7/173; G09G 5/00

(52) U.S. Cl. 725/113; 725/109; 725/112; 345/760

(57) ABSTRACT

There is provided a method for fixing up a last uniform resource locator (LastURL) representing a path and a file name of a MultiPhoto/Video (MPV) asset. A LastURL of an MPV asset can be fixed up by temporarily fixing up the LastURL using rendition asset information. By temporarily fixing up the LastURL using rendition asset information before ultimately fixing up the LastURL, it is possible to provide a user with a quick response almost in real time. Further, a LastURL of an MPV asset can be fixed up by (a) assigning priority to each path where an asset is located, and (b) finding a file corresponding to the asset in accordance with the assigned priority and fixing up the LastURL. By assigning priority to each path, it is possible to efficiently fix up the LastURL.

This application claims the priority of Korean Patent Application No. 2002-71171, filed on Nov. 15, 2002, in the Korean Intellectual Property Office, the disclosure of which is incorporated herein in its entirety by reference.

### BACKGROUND OF THE INVENTION

1. Field of the Invention

The present invention relates to a method for fixing up a last uniform resource locator (LastURL) representing a path and a file name of a MultiPhoto/Video (MPV) asset.

2. Description of the Related Art

Nowadays, multimedia content such as still images, video clips, digital audio, digital text, etc., is processed and reproduced using personal computers.

Further, in accordance with the increased use of devices for producing multimedia content, e.g., digital cameras, digital camcorders, and digital audio players like MPEG Audio Layer-3 (MP3) players or Windows Media Audio (WMA) players, a variety of digital data, i.e., multimedia content, is produced in a tremendous amount.

In order to manage the various and great amount of multimedia content or digital data, users must be accustomed to the file management for the digital data using a personal computer (PC). Further, when defining an attribute, e.g., an order or a method of reproduction, of the digital data and reproducing the attribute defined data through a device other than a PC, occasionally, the attribute data is lost and only the original data is transferred to the device. That is, interoperability of the data and the attribute thereof between the PC and home appliances such as a television (TV) receiver or other devices for producing multimedia data is very weak.

For example, if a user captures images using a digital camera and watches the captured images by implementing a slide show function, a panorama function, or a multi-shot function, the attribute data defined in connection with the implemented function, e.g., the data related to an order or a time interval for the slide show, the relationship between the captured images and the displayed images, etc., is stored together with the original data of the captured images. When connecting the digital camera with a TV receiver using a typical audio/video (AV) cable, the image data and the attribute data stored in the digital camera can be transferred to the TV receiver, and therefore, the user can enjoy the images as their attributes are defined. However, when connecting the digital camera with a PC using a universal serial bus (USB) cable, only the original image data is transferred and the attribute data is lost. This is because the digital camera and the PC adopt different information architectures and data processing methods with each other. As described above, the PC does not recognize the attribute data, i.e., metadata stored in the digital camera.

In order to overcome this interoperability drawback regarding data between digital devices, a standard called MultiPhoto/Video (MPV) has been recently proposed. The MPV standard, developed by Optical Storage Technology Association (OSTA) and International Imaging Industry Association (I3A), includes specifications for manifest, metadata, and practice formats to process and reproduce collections of digital multimedia content such as still images, video clips, audio, etc., which can be stored in recording media such as optical discs, memory cards, or computer hard discs, and exchanged through Internet services.

The MPV standard is generally classified into two groups: the MPV core specification (MPV Core Spec. 0.90 WD) and the MPV profile specification. The MPV Core includes three basic elements: collection, metadata, and identifier. The collection includes a manifest as a root member, an album, marked assets (MarkedAsset), and an asset list (AssetList). There are two kinds of assets: a simple media asset such as still images, video clips, digital audio, digital text, etc., and a composite media asset such as stills with audio, still multi-shot sequences, still panorama sequences, etc. The identifier includes a last uniform resource locator (LastURL) representing a path and a file name of an asset, an instance identification (InstanceID) code identifying each asset, a document identification (DocumentID) code that is identically assigned to the original data and the data derived from the original data, a content identification (ContentID) code that is produced whenever an asset is used for any purpose, and a local identification code that is a local variation within the metadata.

FIG. 1 shows a general architecture of an MPV file. Referring to FIG. 1, a manifest 110 includes metadata 120 including basic profile data and presentation profile data, an album 130 representing a collection of assets, and an AssetList 140 for explaining the assets included in the album 130. The album 130 is comprised of three sections: background 131, foreground 132, and rendition 133. The background 131 includes background assets that are used as background when the album is reproduced, and the foreground 132 includes foreground assets that are shown in front when the album is reproduced.

The AssetList 140 includes an asset link (AssetLink) 141 comprised of an instance identification (InstanceID) code 142 which is uniquely assigned to each asset, a content identification (ContentID) code 143 which is produced whenever an asset is used for any purpose, a last uniform resource locator (LastURL) 144 representing a path and a file name of an asset, metadata 145, rendition 146, and a document identification (DocumentID) code 147. The InstanceID code is a unique identification code of each asset, and is hidden within the corresponding asset data as shown in FIG. 4.

MPV software reads and reproduces assets based on the information recorded in an MPV file having the architecture as shown in FIG. 1. That is, the MPV file is interposed between and connects the MPV software and the data called asset. The MPV file system is very similar to an existing file system, and is understood as an upper level file system.

The MPV software controls assets using the LastURL 144 recorded in the MPV file as shown in FIG. 1. However, in a PC environment, the MPV asset is exposed not only to the MPV software but also to other application software, and can be subject to control of the other application software. That is, the asset can be renamed, moved, or deleted under the control of the other application software, and therefore, the content of the MPV file system can be changed from that of the actual asset. Particularly, the LastURL representing a path and a file name can be damaged.

FIG. 2 shows an example of a situation where the MPV asset is changed using application software other than MPV software. MPV software 210 controls an A.JPG asset 230 using a LastURL 221 recorded in an MPV file 220. If the A.JPG asset 230, i.e., the name thereof, is changed to a B.JPG asset 250 using other application software 240, the MPV software 210 cannot control the corresponding asset using the LastURL 221 recorded in the MPV file 220, which still represents the A.JPG asset 230. In this event, the MPV software 210 determines that the LastURL 221 has been damage. The MPV standard includes a method for fixing up such damaged LastURL.

FIG. 3 is a flowchart of a conventional method for fixing up a LastURL according to the MPV standard. Referring to FIG. 3, a path is extracted from a LastURL of an asset (Step S310), and the files having the same extension with the asset are detected from a directory represented by the extracted path (Step S320). After the InstanceID codes of the detected files are compared with that of the asset (Step S330), it is examined if there is a corresponding file that has the same InstanceID code with the asset (Step S340), and if so, the LastURL is fixed up with the path and the file name of the corresponding file (Step S350). Since the InstanceID code is a unique identification code of each asset and is included in the corresponding asset data, it is possible to find out the wanted asset using the InstanceID code. Here, the term “fix up” includes moving or copying the detected path of the corresponding file into the LastURL, and renaming the file name recorded in the LastURL with that of the corresponding file. If the corresponding file is not found out in Step S340, other procedure, e.g., searching for a whole hard disc drive (HDD) is applied (Step S360).

The conventional method as described above takes a long time to fix up the LastURL, and therefore, it is difficult to implement instant reproduction to satisfy a user. Further, in the event that a wanted file is not found out in a path of the LastURL, additional time is required for, e.g., searching an entire hard disc drive, and accordingly, a long time is required to fix up the LastURL.

### SUMMARY OF THE INVENTION

The present invention provides a method for quickly fixing up a LastURL of an MPV asset by instantly responding to a user's control instruction.

Further, the present invention provides a method for fixing up a LastURL of an MPV asset without wasting time, by efficiently finding a wanted asset.

According to an aspect of the present invention, there is provided a method for fixing up a LastURL representing a path and a file name of an MPV asset, which includes temporarily fixing up the LastURL using rendition asset information. By temporarily fixing up the LastURL using rendition asset information before ultimately fixing up the LastURL, it is possible to provide a user with a quick response almost in real time.

According to another aspect of the present invention, there is provided a method for fixing up a LastURL representing a path and a file name of an MPV asset, which includes the steps of (a) assigning priority to each path where an asset is located, and (b) detecting a file corresponding to the asset in accordance with the assigned priority and fixing up the LastURL. By assigning priority to each path, it is possible to efficiently fix up the LastURL.

### BRIEF DESCRIPTION OF THE DRAWINGS

The above aspects and advantages of the present invention will become more apparent by describing preferred embodiments thereof with reference to the attached drawings in which:

FIG. 1 shows a general architecture of a MultiPhoto/Video (MPV) file;

FIG. 2 shows an example of a situation where an MPV asset is changed using application software other than MPV software;

FIG. 3 is a flowchart of a conventional method for fixing up a last uniform resource locator (LastURL) of an MPV asset according to the MPV standard;

FIG. 4 schematically shows a method for fixing up a LastURL according to an aspect of the present invention;

FIG. 5 schematically shows an MPV file when fixing up a LastURL in accordance with the method of FIG. 4;

FIG. 6 shows specific source codes of an MPV file when fixing up a LastURL in accordance with the method of FIG. 4;

FIG. 7 schematically shows a method for fixing up a LastURL according to another aspect of the present invention;

FIG. 8 shows an example of how priority can be assigned to each path in accordance with the method of FIG. 7;

FIG. 9 shows another example of how priority can be assigned to each path in accordance with the method of FIG. 7; and

FIG. 10 shows a result of a simulation for testing the performance of the present invention, as shown in FIG. 8, for example.

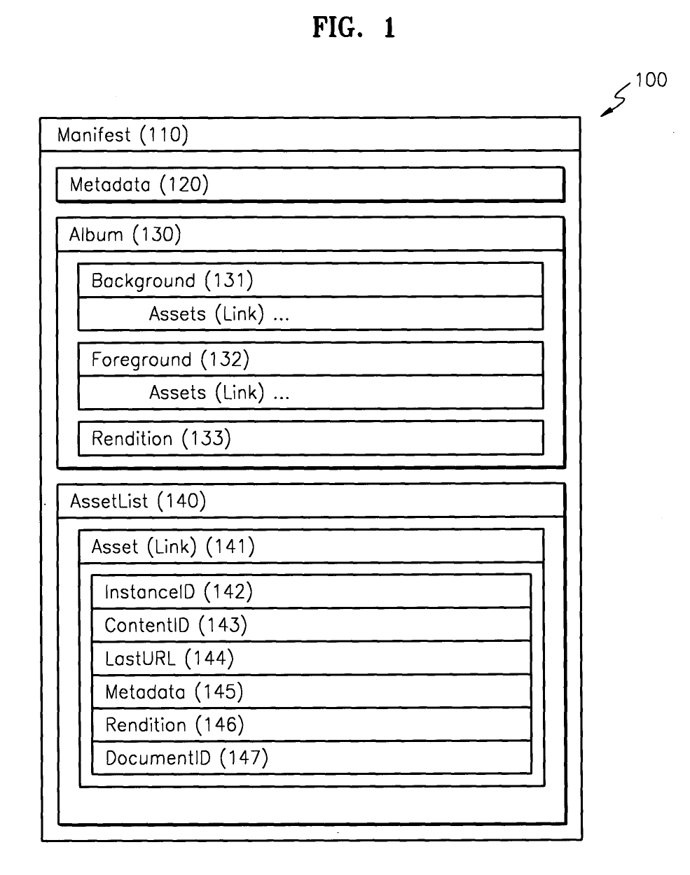

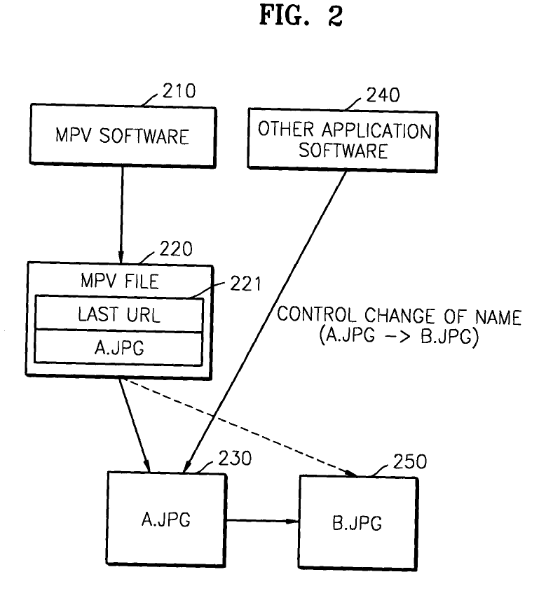

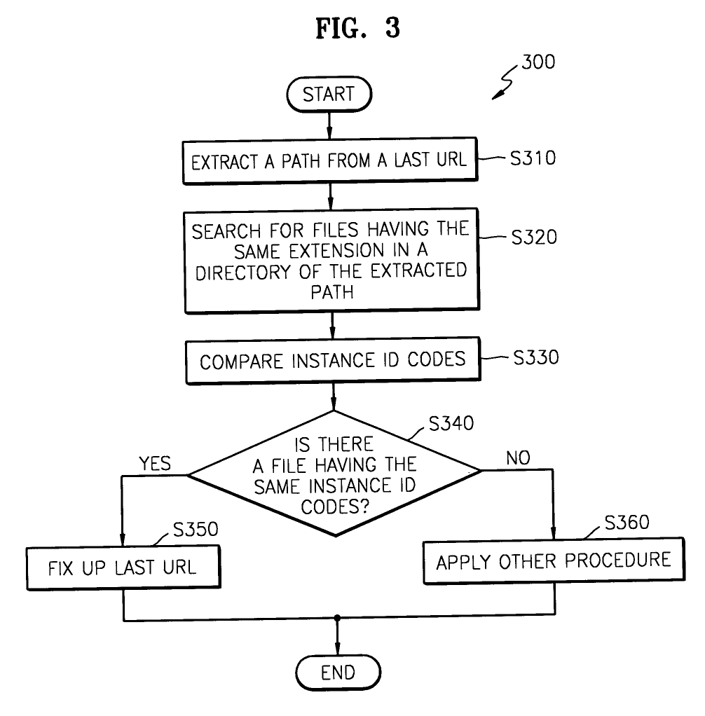

### DETAILED DESCRIPTION OF THE INVENTION

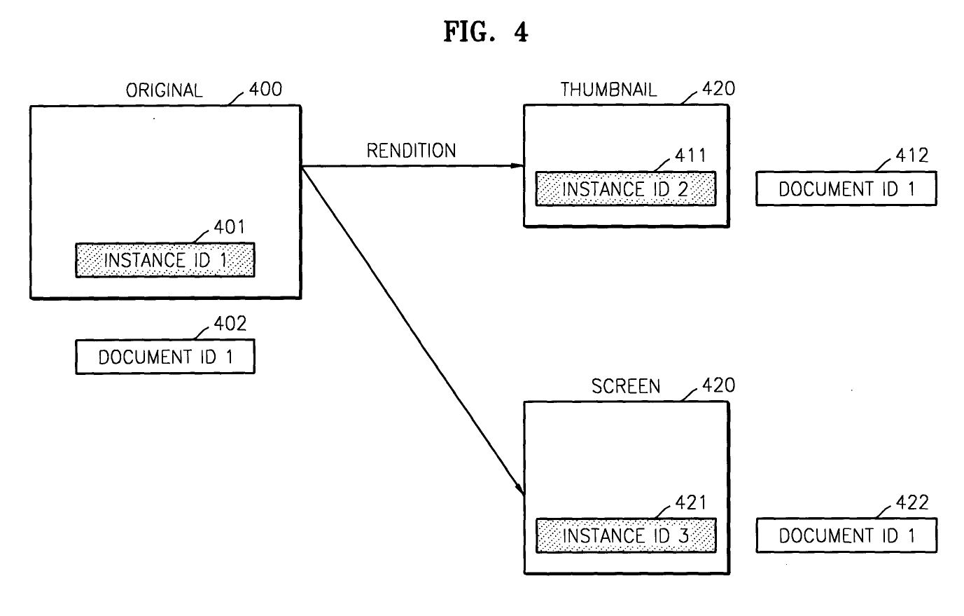

Now, a method for fixing up a LastURL of an MPV asset according to an aspect of the present invention will be described with reference to FIGS. 4 to 6.

FIG. 4 schematically shows a method for fixing up a LastURL according to an aspect of the present invention. MPV software can provide a rendition of an original asset 400 in data having various resolutions and formats. The term “rendition” means production of a derived asset having an image identical to that of the original asset in a different resolution or in a different size. Definable terms related to a rendition member include a “master”, which means an original asset, a “thumbnail”, which is a reduced asset and is used for a preview, a “screen”, which reduces or enlarges and transforms the master in a resolution of a screen to be reproduced, and other terms such as HighRes, LowRes, PrintShow, etc.

Referring to FIG. 4, the original asset 400 is subject to rendition to produce a thumbnail 410 and a screen 420. When the original asset 400 is subject to rendition, InstanceID and DocumentID codes are generated for the rendition asset. Since the InstanceID code is a unique code of each asset, the original asset and each rendition asset have different InstanceID codes. However, the DocumentID codes of original asset and each rendition asset are the same with each other. For example, in FIG. 4, the original asset 400 has an InstanceID_1 code 401 and a DocumentID_1 code 402, the thumbnail rendition asset 410 has an InstanceID_2 code 411 and a DocumentID_1 code 412, and the screen rendition asset has an InstanceID_3 code 421 and a DocumentID_1 code 422. According to an aspect of the present invention, there is provided a method for quickly fixing up a LastURL of an MPV asset by temporarily fixing up the LastURL using the rendition assets, even though some parameters such as resolutions are not matched. That is, if the LastURL of the original asset referred to by the MPV software is wrong, the LastURL is temporarily fixed up and is referred to by the MPV software using the renditions assets even though their resolutions or sizes are different, and in accordance with availability of system resources, the actual original asset is found for the purpose of ultimately fixing up the LastURL.

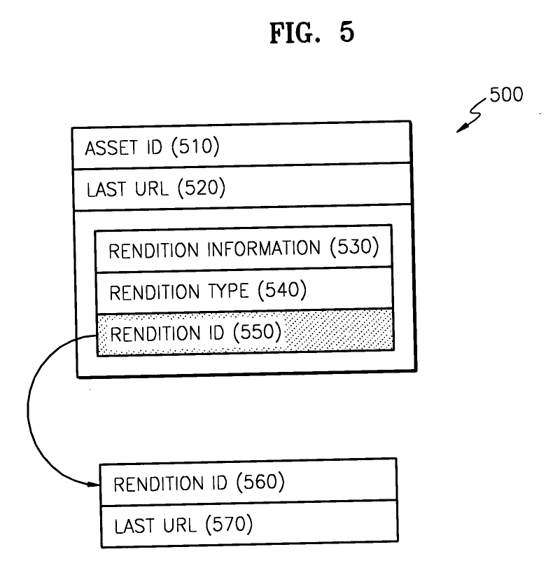

FIG. 5 schematically shows an MPV file when fixing up the LastURL thereof in accordance with the method of FIG. 4. An asset member 500 includes an AssetID code 510, which is an identification code of the asset itself, and a LastURL 520, which represents a path indicating a location of the asset and the name of a file including the asset. In addition, the asset member includes rendition information 530, which includes rendition type information 540 representing a type of a rendition asset, and rendition identification (ID) 550 identifying the rendition asset. A rendition ID member 560 found with reference to the rendition ID 550 includes a LastURL 570. The LastURL 570 represents a path designating a location of the rendition asset and the name of a file including the rendition asset.

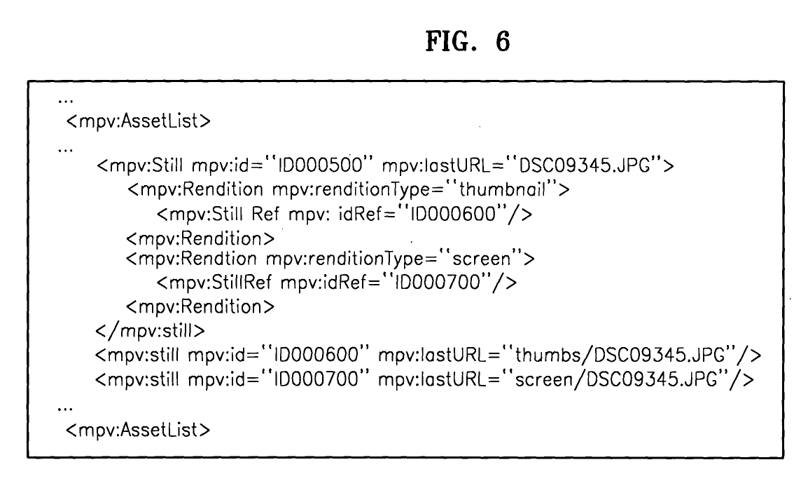

FIG. 6 shows specific source codes of an MPV file when fixing up a LastURL in accordance with the method of FIG. 4. For example, an original asset has an asset format of “still”, an ID code of “ID000500”, and a LastURL of “DSC09345.JPG”, a rendition asset has a rendition type of “thumbnail”, an asset format of “still, and an ID code of “ID000600”, and another rendition asset has a rendition type of “screen”, an asset format of “still”, and an ID code of “ID000700”.

The LastURL of the rendition asset having the ID code of “ID000600” is “thumbs/DSC09345.JPG”, and that of the rendition asset having the ID code of “ID000700” is “screen/DSC09345.JPG”. That is, there are two rendition assets including a thumbnail asset and a screen asset, which have the same content with the original asset, although their InstanceID codes are different from that of the original asset, and the resolutions are different from each other. Therefore, if the original asset is not found in the LastURL of the original asset having the ID code of ID000500, the LastURL thumbs/DSC09345.JPG of the rendition asset having the ID code of ID000600 or the LastURL screen/DSC09345.JPG of the rendition asset having the ID code of ID000700 is found instead and is temporarily fixed up, and in accordance with availability of system resources, the InstanceID code is searched for to ultimately fix up the LastURL.

According to the method described above, the MPV software quickly responds to a user's control instruction using the temporarily fixed up LastURL, and thereafter, the LastURL is ultimately fixed up through an actual fixing up algorithm so that the reproduction can be perfectly performed. It is noted that the temporarily fixed up LastURL should be recorded in metadata to indicate that the LastURL has not been actually fixed up, but temporarily fixed up.

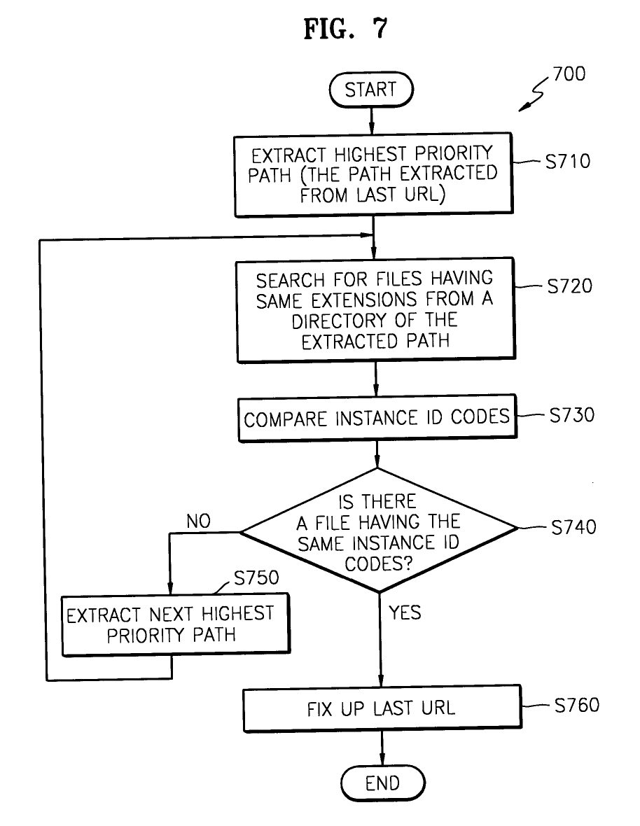

Now, a method for fixing up a LastURL of an MPV asset according to another aspect of the present invention will be described with reference to FIGS. 7 to 10.

There are many paths and files in a hard disc drive of a personal computer, and it takes a long time to review all the paths and files and compare their InstanceID codes one by one. Therefore, according to another aspect of the present invention, there is provided a method for fixing up a LastURL by assigning high priority to the files of the path where a wanted file is likely to exist, and low priority to the files of the path where the wanted file is not likely to exist, and searching for the high priority files first.

FIG. 7 schematically shows a method for fixing up a LastURL according to another aspect of the present invention. First of all, priority of each path of a hard disc drive is assigned on a predetermined basis, although it is not shown in FIG. 7. Then, the highest priority path is extracted (Step S710). The highest priority path might be the path represented by the original LastURL. Then, the files having the same extensions are searched for in a directory designated as the highest priority path (Step S720). Then, the InstanceID codes of the files having the same extensions are compared (Step S730). If there is a file having the same InstanceID code (Step S740), then the LastURL is fixed up (Step S760), and if not, the next priority path is extracted (Step S750) and steps from Step S720 are repeated. By searching for a higher priority path earlier as described above, it is possible to shorten the time to find out the wanted file.

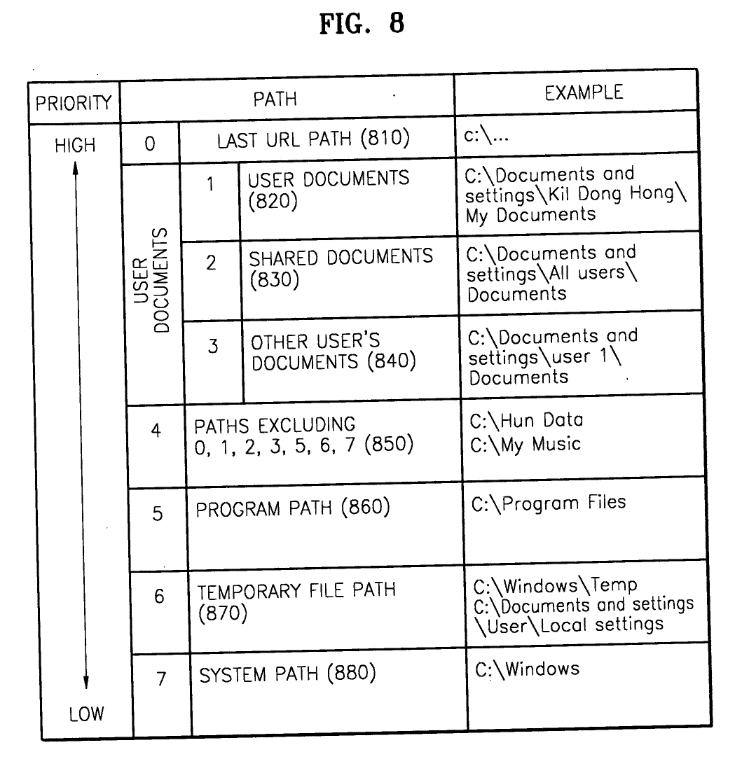

FIG. 8 shows an example of the priority of each path assigned in accordance with the method of FIG. 7. Since a wanted file is most likely to exist on the path 810 extracted from the LastURL, the path 810 extracted from the LastURL has the highest priority. Next, since a user frequently manipulates an asset, the wanted file is likely to exist on the paths related to user document files unless the wanted file exists in the path extracted from the LastURL. Therefore, the next highest priority is assigned to the paths including the user document files, e.g., a user document file path 820 such as “C:\Documents and Settings\User\My Documents”, a shared document file path 830 such as “C:\Documents and Settings\All Users\Documents”, or another user's document file path 840 such as “C:\Documents and Settings\User1\Documents”. Since the wanted file is not likely to exist on a program file path 860 such as “C:\Program Files”, a temporary file path 870 such as “C:\Windows\Temp” or “C:\Documents and Settings\User\Local Settings”, and a system file path 880 such as “C:\Windows”, low priority is assigned to the program file, temporary file, and system file paths. The other paths 850 for the files that are neither document files and programs nor system files are provided with intermediate priority.

It is noted that the sixth and seventh priority paths, i.e., the temporary file path 870 and the system file path 880 may not be selectively searched for because there is little possibility to actually find out a damaged asset on those paths. However, when an Internet profile is determined and is implemented in the personal computer, there is a possibility that the damaged asset can be found on an Internet temporary file path of the sixth priority path, i.e., the temporary file path 870.

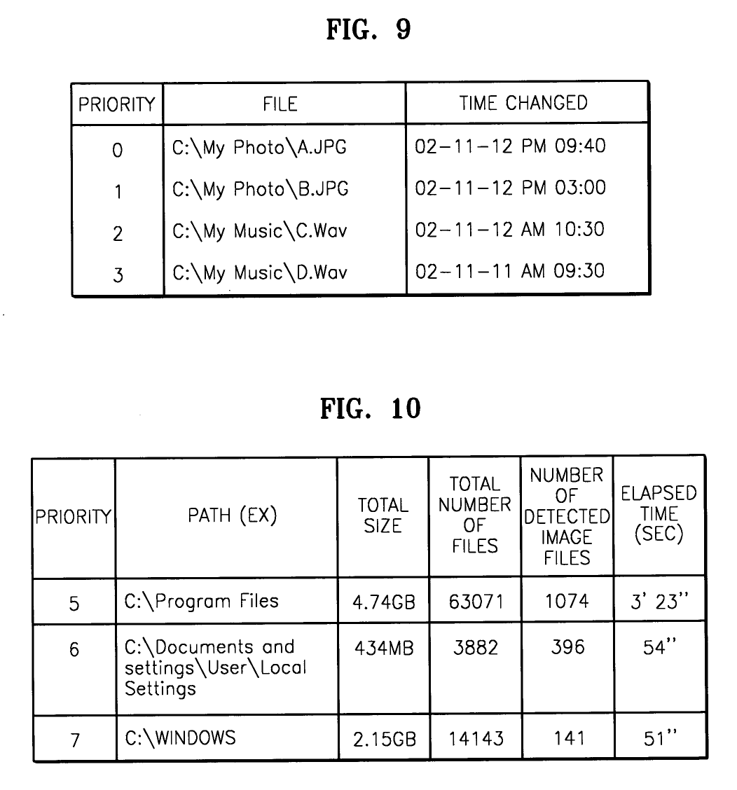

FIG. 9 shows another example of how priority of each path is assigned in accordance with the method of FIG. 7. That is, the priority is determined based on a time when a file is changed. As the most recently changed file is most likely to be the damaged asset file, the higher priority is assigned to the more recently changed file on a basis of the time when the file is changed.

Referring to FIG. 9, the file changed at 02-11-12 09:40 p.m., C:\My Photo\A.JPG, has priority 0, the file changed at 02-11-12 03:00 p.m., C:\My Photo\B.JPG, has priority 1, the file changed at 02-11-12 10:30 a.m., C:\My Music\C.WAV, has priority 2, and the file changed at 02-11-12 09:30 a.m., C:\My Music\D.WAV, has priority 3.

FIG. 10 shows a result of a simulation for testing the performance of the example of FIG. 8. The simulation is implemented using a personal computer to which the MPV can be actually applied, characterized by a Pentium VI 1.6 GHz CPU, an 80 GB HDD, a Windows XP Professional OS, and 512 MB RAM. Assuming that there are four users, the total saved search time is 7 minutes and 50 seconds (3 minutes and 23 seconds +54 seconds×4 users+51 seconds). When applying an MPV in a personal computer, the time for comparing files should also be included, and therefore, the time for comparing 1,611 files can be additionally saved. That is, it is possible to save time longer than 7 minutes and 50 seconds. It is noted that different test results may be obtained based on the personal computer used for the test or the user's behaviours.

A method for fixing up a LastURL according to the present invention can be applied to and implemented by not only the personal computer as described above, but also various digital products such as a personal video recorder (PVR), a digital video disc (DVD) recorder, etc.

As described above, according to the present invention, it is possible to quickly, almost in real time, respond to a user's control instruction by temporarily fixing up the LastURL using rendition asset information before ultimately fixing up the LastURL. Further, it is possible to efficiently find out a wanted file without loss time while fixing up a LastURL by assigning priority to each path where an asset is located and finding a file corresponding to the asset in accordance with the assigned priority.

While the present invention has been particularly shown and described with reference to preferred embodiments thereof, it will be understood by those of ordinary skill in the art that various changes in form and details may be made therein without departing from the spirit and scope of the present invention as defined by the appended claims.

What is claimed is:

1. A method for fixing up a last uniform resource locator (LastURL) representing a path and a file name of a MultiPhoto/Video (MPV) asset, comprising a step of temporarily fixing up the LastURL using rendition asset information.

2. The method for fixing up the LastURL according to claim 1, further comprising a step of ultimately fixing up a LastURL using a file pointed to by a path included in the LastURL.

3. The method for fixing up the LastURL according to claim 2, wherein the step of ultimately fixing up the LastURL is implemented based on an availability of system resources.

4. The method for fixing up the LastURL according to claim 1, wherein the step of temporarily fixing up is implemented using a document identification (DocumentID) code of the rendition asset information.

5. A method for fixing up a last uniform resource locator (LastURL) representing a path and a file name of a MultiPhoto/Video (MPV) asset, comprising the steps of:
(a) assigning priority to each of a plurality of paths where an asset is located, and
(b) detecting a file corresponding to the MPV asset in accordance with the assigned priority and fixing up the LastURL.

6. The method for fixing up the LastURL according to claim 5, wherein the step (a) includes assigning a highest priority to one of said plurality of paths extracted from the LastURL of the corresponding MPV asset.

7. The method for fixing up the LastURL according to claim 5, wherein the step (a) includes assigning high priority to at least one of said plurality of paths that include user document files.

8. The method for fixing up the LastURL according to claim 5, wherein the step (a) includes assigning low priority to at least one of said paths that include at least one of a program file, a temporary file, and a system file.

9. The method for fixing up the LastURL according to claim 5, wherein the step (a) includes assigning higher priority to more recently changed files of said plurality of paths, based on a time when a file is changed.
